(19) United States
(12) Patent Application Publication
(10) Pub. No.: US 2017/0049064 A1
(43) Pub. Date: Feb. 23, 2017

(54) HIGH DENSITY FARMING APPARATUS, SYSTEM AND METHOD

(71) Applicant: Jack Griffin, Philadelphia, PA (US)

(72) Inventor: Jack Griffin, Philadelphia, PA (US)

(21) Appl. No.: 15/088,894

(22) Filed: Apr. 1, 2016

Related U.S. Application Data
(60) Provisional application No. 62/128,294, filed on Mar. 4, 2015.

(51) Int. Cl. A01G 31/06; A01G 7/04

(52) U.S. Cl. CPC A01G 31/06; A01G 7/045; A01G 2031/006

(57) ABSTRACT

The disclosure is directed to providing a readily scalable hydroponic and vertical farming apparatus, system and method that remedies the foregoing issues, that is available in limited space and at high density, such as in urban areas, that presents low farming costs, and that improves crop yield and health.

### CROSS-REFERENCE TO RELATED APPLICATION

The present invention claims priority to U.S. Provisional Application No. 62/128,294 filed Mar. 4, 2015, the entirety of which is incorporated by reference herein.

### BACKGROUND

Field of the Invention

The present disclosure is directed generally to farming, and more particularly is directed to high density, hydroponic apparatuses, systems and methods.

Background of the Disclosure

Hydroponic farming, and so-called “vertical farming,” is well known in the present state of the art. However, the current states of these types of farming suffer from a variety of issues. These issues include a lack of sufficient density for the farming, which leads to a need to stack farming levels in vertical farms to too great an extent, insufficient or improper lighting, the need the clean hydroponic systems on a too frequent basis, and a lack of crop health, among many other issues.

Thus, the need exists for a readily scalable hydroponic and vertical farming apparatus, system and method that remedies the foregoing issues, that is available in limited space, such as in urban areas, that presents low farming costs, and that improves crop yield and health.

### SUMMARY OF THE DISCLOSURE

The disclosure is directed to providing a readily scalable hydroponic and vertical farming apparatus, system and method that remedies the foregoing issues, that is available in limited space and at high density, such as in urban areas, that presents low farming costs, and that improves crop yield and health.

### BRIEF DESCRIPTION OF THE FIGURES

The present disclosure is illustrated by way of example and not limitation in the figures of the accompanying drawings, in which like references indicate similar elements and in which:

FIG. 1 shows an embodiment of the disclosure;

FIG. 2 shows an embodiment of the disclosure;

FIG. 3 shows an embodiment of the disclosure;

FIGS. 4A and 4B show embodiments of the disclosure; and

FIGS. 5A and 5B show embodiments of the disclosure.

### DETAILED DESCRIPTION

It is to be understood that the figures and descriptions of the present disclosure have been simplified to illustrate elements that are relevant for a clear understanding of the discussed embodiments, while eliminating, for the purpose of clarity, many other elements found in known apparatuses, systems, and methods. Those of ordinary skill in the art may thus recognize that other elements and/or steps are desirable and/or required in implementing the disclosure. However, because such elements and steps are known in the art, and because they consequently do not facilitate a better understanding of the disclosure, for the sake of brevity a discussion of such elements and steps is not provided herein. Nevertheless, the disclosure herein is directed to all such elements and steps, including all variations and modifications to the disclosed elements and methods, known to those skilled in the art.

Exemplary embodiments are provided so that this disclosure will be thorough, and will fully convey the scope to those who are skilled in the art. Numerous specific details are set forth, such as examples of specific components, devices, and methods, to enable a thorough understanding of embodiments of the present disclosure. It will be apparent to those skilled in the art that specific details need not be employed, that is, that the exemplary embodiments may be embodied in many different forms and thus should not be construed to limit the scope of the disclosure. For example, in some exemplary embodiments, well-known processes, well-known device structures, and well-known technologies are not described in detail.

The terminology used herein is for the purpose of describing particular example embodiments only and is thus not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

As to the methods discussed herein, the method steps, processes, and operations described herein are not to be construed as necessarily requiring their performance in the particular order discussed or illustrated, unless specifically identified as having an order of performance. It is also to be understood that additional or alternative steps may be employed.

When an element or layer is referred to as being “on”, “atop”, “engaged to”, “connected to,” “coupled to,” or a like term or phrase with respect to another element or layer, it may be directly on, engaged, connected or coupled to the other element or layer, or intervening elements or layers may be present. In contrast, when an element is referred to as being “directly on,” “directly engaged to”, “directly connected to”, “directly atop”, or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The various exemplary embodiments will be described herein below with reference to the accompanying drawings. In the following description and the drawings, well-known functions or constructions are not shown or described in detail since they may obscure the disclosed embodiments with the unnecessary detail.

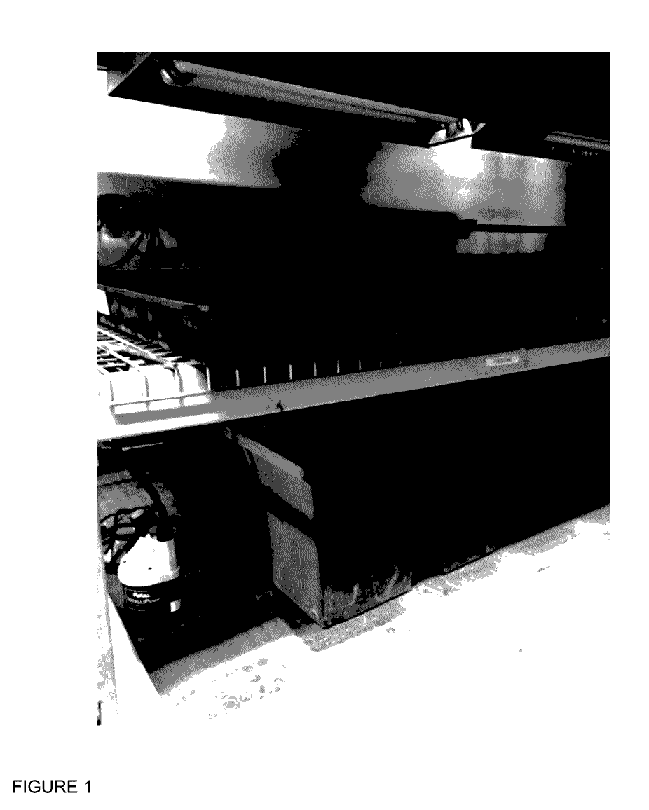

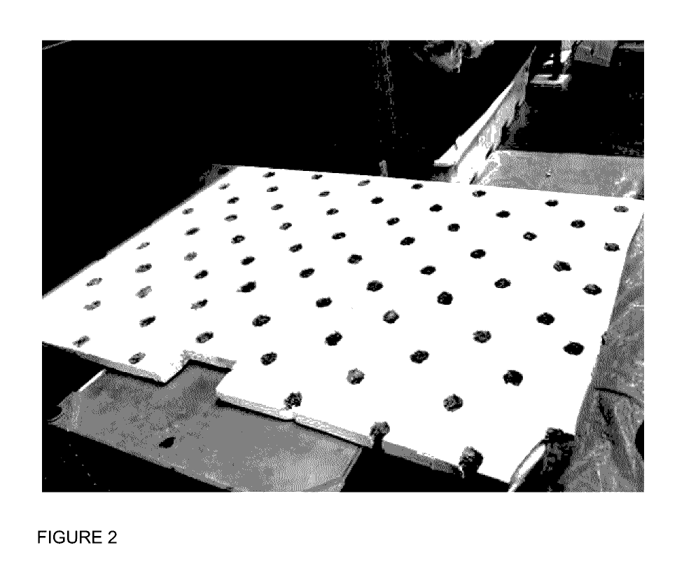

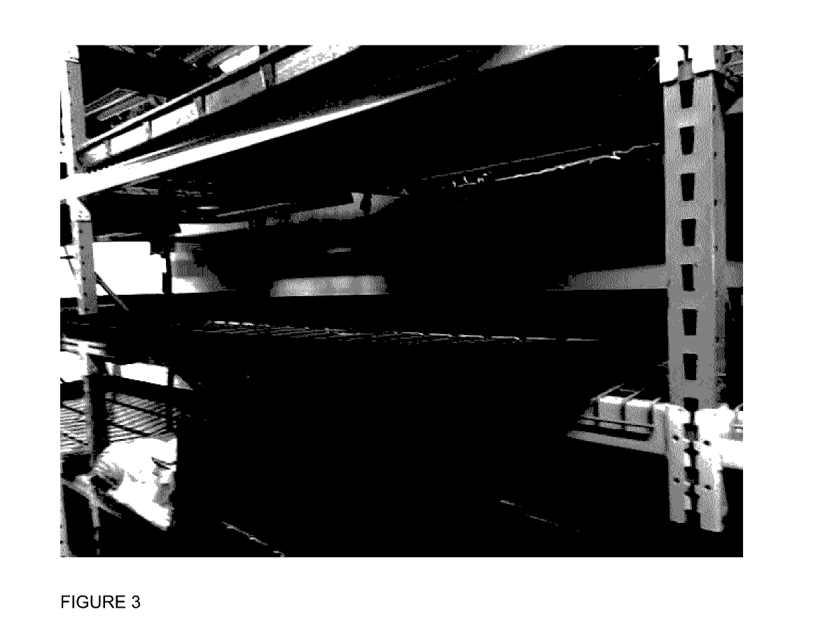

The present invention is and includes an apparatus, system, and method for high density farming. The referenced apparatus, system, and method may employ an ebb and flow, table-based water system that may be stacked above and below other alike flooded tables, as shown in the example of FIGS. 1, 2 and 3. As illustrated in FIGS. 1, 2 and 3, the present invention is comprised of numerous basic components: a water-based nutrient bath resident in a tank having a volume of at least 250 gallons, wherein included within the substantially environmentally sealed tank is a pump for pumping the water from the tank up to each level of the high-density tables, on the same side of each table, such as on the left thereof, and an out-flow system on each table comprised of a non-block drain or drains whereby the water flows across the table and down the drain(s) based on the pull of gravity and back into the minimum 250 gallon tank that includes the nutrient bath; each of a plurality of multi-level flow tables in which crops are grown, and which preferably comprise between two and eight levels, one on top of the other, of, for example, 6-10 foot long water tables, and preferably 8 foot water tables; a lighting system that provides light above and in close but not overly close proximity to each of the multi-level flow tables, wherein the lights may comprise induction or LED lighting and may move across and/or down the table; and a floating base “float” within each table, such as may be comprised of foam, wherein the floating base may be any substance suitable to float atop the water flowing from one side of each table to the other, and to absorb heat from the lighting.

As described, the present invention may be adapted, based on adjustment of the nutrient bath and lighting, to accommodate growth of nearly any particular crop. For example, it is well known in the hydroponics field that for every 5-10 degrees above 70 degrees Fahrenheit that the water/plant roots are heated, oxygenation to the plant may be cut by up to half. It is for this reason that, in the known art, the use of induction lighting is typically avoided. However, the use of the heat absorbing float in the present invention allows for the use of induction lighting, and minimizes the need to make significant adjustments in the proximity of the lights and the temperature of the water for various different crops.

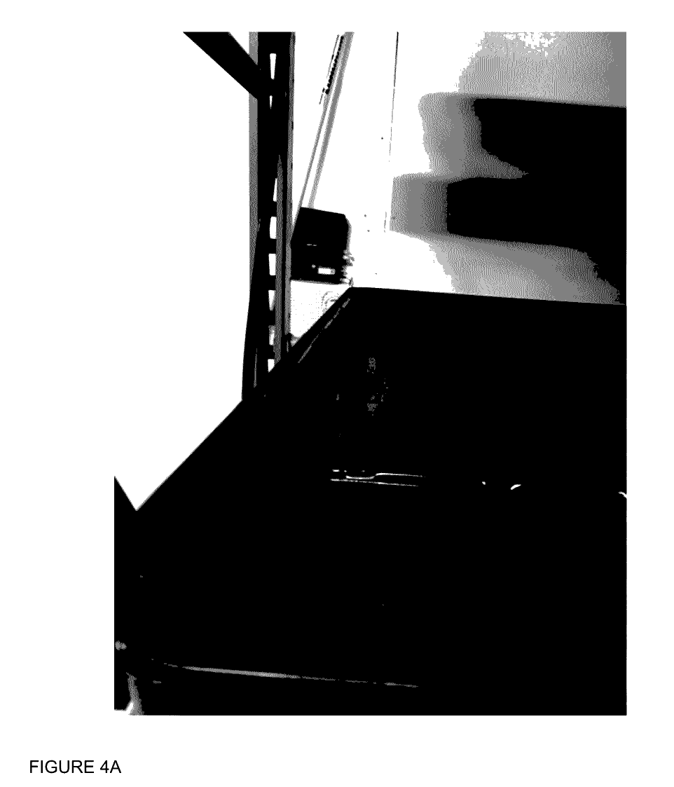

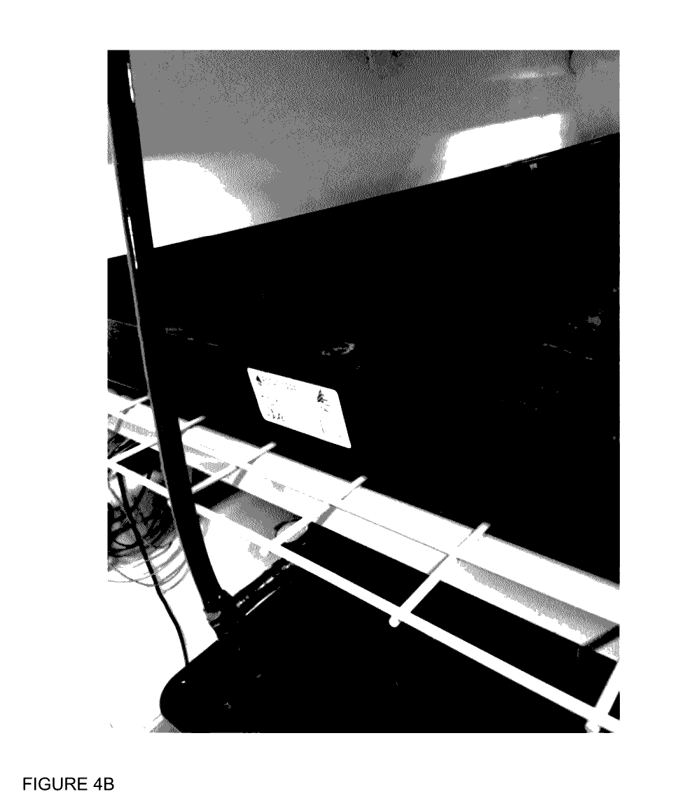

Each table may be standard flow table as is known in the pertinent art, and as is shown with particularity in FIGS. 4A and 4B. For each table, as shown, an inlet may reside on one end of the table, and water may be “bubbled” up through that inlet into the table, where after the water disperses and flows across the table to the other side of the flow table, at which point a single drain may receive the water and allow flow of the water down the other side of the flow table i.e. at the other side of the multi-level farming stack, back to the tank. The water bubbled up from the tank may preferably be relatively cool initially, and may remain so due to the insulation of the water from the lights performed by the floating foam when the water returns to the tank.

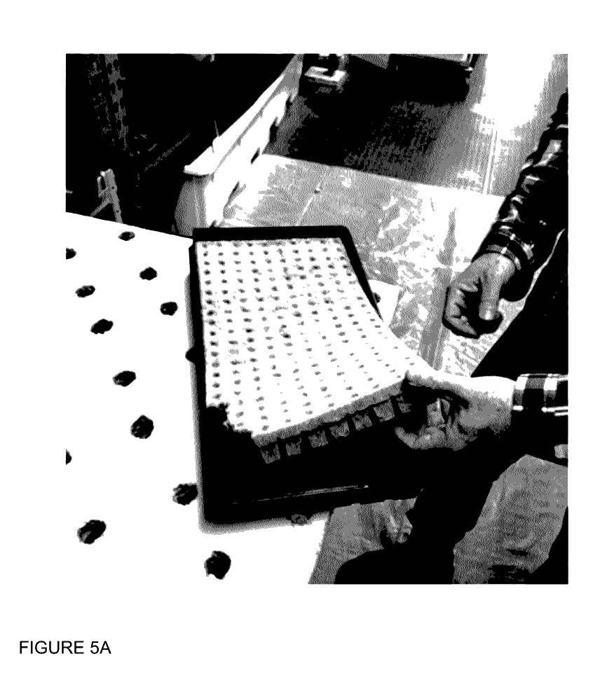

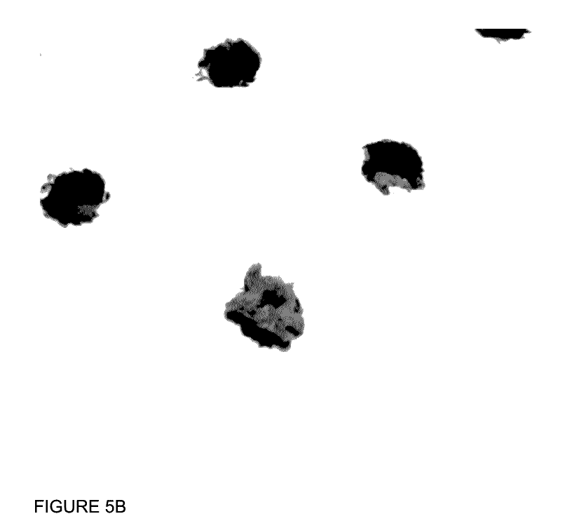

FIG. 5A is an illustration of a foam float for floating atop the nutrient water in a flow table. Of note, each flow table may include one or more floats as may most readily allow for scaling of crops grown in each flow table. Thus, for example, each float may be readily modifiable, such as being easily cut, to provide any desired density for particular plants to grown within the float. As mentioned herein, each float may comprise, for example, foam, and may be of a suitable thickness, such as between 1 and 4 inches, to suspend a growing plant at the desired height above the water and to sufficiently insulate the plants roots and the nutrient water from the heat provided by overhead lighting, such as the induction lighting referenced herein.

Moreover, and as is illustrated in FIGS. 5A and 5B, each plant seedling may be initially grown in, for example, rock wool, also known as volcanic rock wool, to improve germination of each plant. Accordingly, when each plant reaches a desired height, it may be readily replanted within the float, assuming that each hole in the float has been cut to size to receive the size of the rock wool in which the germinated seedling resides. This, too, is clearly illustrated with respect to FIG. 5B.

Accordingly, the present invention provides a simple and scalable multi-level hydroponic farming system, wherein broad spectrum lighting, such as induction lighting, may be used without overheating plants, and wherein floats may be employed of any desired depth and density to optimize yield on a crop by crop basis. Moreover, the height of each flow table, and its distance from the lighting system, may preferably be adjustable, such as by a simple pulley and catch or manual adjustment shelving system. The number of platforms, the depth of the float, and the distance from the lighting system for each crop may be entirely adjustable based on the crop being grown.

Thereby, crops may be grown in almost any setting, in a “flash farm” or “artisan farm” context. That is, multi-level farming may be performed in spaces ranging from 32 sq. ft., that is, the size of a standard float and shelving at a single level, to 10,000 sq. ft. or more. This artisan farming requires no special skills, and allows for, for example, restaurants to engage in their own farming of crops used, and further for farming to be readily available even in urban areas where space is at a premium. In an exemplary density, 60 float tables may thus be provided, wherein each float table may be 8 ft. by 4 ft. and as little as 1,600 sq. ft. of space.

Yet further, the non-use in the present invention of pesticides or animal waste allows for heightened cleanliness of the food growing environment. Thus, for example, various restrictions typically employed in electronics clean rooms may likewise be employed in the instant invention to maintain the cleanliness of the present farming methods. For example, various methods may be employed to keep out bugs, growth centers may be outside food-free, cleanliness may be optimized, airlocks may be provided at entry and exit and kosher food protocols may be followed. Of course, the simplicity and scalability of the instant invention also allows for improved cleanliness and maximum crop yield without engaging in the aforementioned clean room protocols.

As mentioned, farming may thereby be performed even in urban areas, or within businesses, such as restaurants. Accordingly, artisan famers may engage in their own farming and/or may license the right to employ the apparatuses, systems and methods discussed herein. Similarly, businesses may engage in farming on site, and may hire third parties to come in and service the farm on an as-needed basis, or at pre-determined intervals, in a manner akin to office coffee service replenishment systems that are known in the art.

Various advantages are provided in accordance with the described apparatuses, systems, and methods. For example, inclusion of a cut-off point detector in each tray for the float level allows for the prevention of flooding if the float rises to too high a level. Such float cut-off switches may be very simple mechanical switches, unlike flooding prevention switches that are needed in the current art, which are far more complex. Moreover, as mentioned above, the absorption of heat by the provided floats allows for the use of broad spectrum lighting, such as induction lights, which provide for improved plant growth for other than flowering plants as compared to LED lights.

Additionally, as a further advantage, the instant invention uses 98% less water than standard farming systems. This is due to the recycling of the water, the enlarged size of the tanks and the substantially sealed nature of the tanks. Because only the plant and evaporation can remove water from the disclosed invention, minimizing evaporation through the relative sealing of the tanks, in conjunction with the increased size of the tanks, minimizes the need to add nutrients or water to the system as frequently as is the case in the known art.

As an additional distinct advantage, the number of human “touch points” in the instant system is appreciably below the known art. Generally, even in hydroponics systems known in the art, the number of human hands that touch food during the growth and processing processes is immense. This leads to Ebola and other food borne diseases. However, in the disclosed invention, each plant is touched only twice, when implanted in the rock wool, and when removed from the rock wool. Cleaning is unnecessary, due to the heightened clean state of growth. Movement or adjustment is unnecessary due to the nature of the lighting system and the float system disclosed herein.

Moreover, a distinct advantage is the exceedingly high density provided by the current invention, in part due to the clean nature of the growth process, and in part due to the larger tanks in the watering system. This high density growth allows for growth in urban areas, which, in the event of a disaster, allows for the availability of food at the point of necessity, without need to bring food from the outside. Moreover, this increased density allows for an increase of over 200 times the traditional farm density—that is, using the disclosed invention, a 15 acre farm may fit in a warehouse of less than 5,000 sq. ft.

Crops may also be improved through the use of the present invention. For example, because the plant has a balanced nutrient bath, providing nutrients, pH levels and the like specific to that plant, and because water at a proper temperature and air are readily available, each plant need not struggle to grow. Consequently, plant growth, and thus taste and quality, are optimized. Moreover, because the suspension of the plants by the float allows the roots of each plant to “reach out” to the water, a low amount of water is needed, but the plant's growth rate is optimized, and the plant's growth rate is further optimized based on the acceptability of the use of broad spectrum lighting.

The present invention may additionally include flushing and filtering systems for the nutrient bath. For example, because, as mentioned herein, water loss is extremely low, and animal waste need not be employed in the instant invention, the need to flush the water tank system arises only very infrequently, such as every four to five months. Additionally, the reuse of the nutrient baths for extended periods of time prevents any contamination of local water systems. Moreover, the clean state of the baths allows for “plant improvement” stations. That is, in the event a nutrient bath is not providing its subject plants to optimize growth or flavor, those plants may be moved to a cleaning station, such as wherein a different bath is provided to clear out plant salts and improve taste. This movement to the plant improvement station does not require that a human pick up each individual plant, but rather that only the foam float be touched, and the foam float be moved from one station to another, thereby the present invention is thoroughly adaptive to clean plant growth, such as through shelf movement, light changes, foam movement, bath recycling, cleanliness stations, lack of need to flush the system, and end stage filtering for nutrient bath flushes.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

Moreover, it can be seen that various features may be grouped together in a single embodiment during the course of discussion for the purpose of streamlining the disclosure. This method of disclosure is not to be interpreted as reflecting an intention that any claimed embodiments require more features than are expressly recited in each claim that may be associated herewith.

What is claimed is:

1. A hydroponic vertical farming system, comprising:
a water-based nutrient bath resident in a tank having a volume of at least 250 gallons;
a pump for pumping the bath from the tank up to at least one high-density table comprising growing crops;
an out-flow system on the table comprised of non-block drains whereby the bath flows across the table and down the drains based on the pull of gravity and back into the tank that includes the nutrient bath;
a lighting system that provides light from points above the growing crops; and
a base float floating on the bath in the table through which the growing crops grow.
